(19) United States
(12) Patent Application Publication
(10) Pub. No.: US 2014/0062863 A1
(43) Pub. Date: Mar. 6, 2014

(54) METHOD AND APPARATUS FOR SETTING ELECTRONIC BLACKBOARD SYSTEM

(71) Applicant: Samsung Electronics Co., Ltd., Gyeonggi-do (KR)

(72) Inventors: Taehyeon YU, Gyeonggi-do (KR); Sejeong NA, Gyeonggi-do (KR); Haeyoung PARK, Gyeonggi-do (KR); Yongchan KEH, Seoul (KR)

(73) Assignee: Samsung Electronics Co., Ltd., Gyeonggi-do (KR)

(21) Appl. No.: 14/012,060

(22) Filed: Aug. 28, 2013

(30) Foreign Application Priority Data
Aug. 28, 2012 (KR) 10-2012-0094014

(51) Int. Cl. G06F 3/00

(52) U.S. Cl. CPC G06F 3/005
USPC 345/156

(57) ABSTRACT

Provided are a method and apparatus for setting an electronic blackboard system. In response to a user input to a control apparatus requesting setting of the electronic blackboard, sensitivity of an IR camera is set so that visible rays are detected. A projector projects an image with a presentation region and a first guider therein for alignment. The IR camera transmits a first captured image of the presentation region, including at least a portion of the first guider, to the control apparatus. The projector is then controlled to project to the screen at least a portion of a second guider corresponding to the first guider in the first image received from the IR camera. The user may then make positional adjustments to the IR camera or projector using the second guider.

### CLAIM OF PRIORITY

This application claims the benefit under 35 U.S.C. §119(a) of a Korean patent application filed on Aug. 28, 2012 in the Korean intellectual property office and assigned serial no. 10-2012-0094014, the entire disclosure of which is hereby incorporated by reference.

### BACKGROUND

1. Technical Field

The present disclosure relates to an electronic blackboard system that projects a blackboard image and enables electronic writing. More particularly, the disclosure relates to setting (e.g., aligning and calibrating) such an electronic blackboard system.

2. Description of the Related Art

Physical blackboards and white boards have been widely used for decades for learning and seminars in various places such as schools, institutions, and offices. Recently, a virtual blackboard, i.e., an electronic blackboard system, has been developed which eliminates the chalk and other drawbacks of the traditional blackboard. In general, the electronic blackboard system may include a projector projecting an image on a screen (e.g., white wall or white board), and an electronic pen radiating infrared rays on the screen. An infrared (IR) camera detects the infrared rays on the screen and based on the detected IR rays, generates IR image information of the screen. This image information is transmitted to a controller, which recognizes a track of the electronic pen from the image information and controls the projector to display the pen's track on the screen.

Generally, an infrared LED may be attached to a nib of the electronic pen. For example, when the nib makes contact with the screen, the infrared LED may be turned-on to radiate IR rays. The user simulates writing on a physical blackboard with chalk by making electronic pen contact with the screen whereby the projector instantly projects white light at the points of contact.

Accordingly, it is important to accurately recognize a touched point of an electronic pen on the image projected on a screen in the electronic blackboard system. Alignment and calibration are required to precisely recognize the touched point.

The alignment is an operation which includes a presentation region of a screen on which an image is projected in a vision field (shooting region) of an IR camera. For this alignment, the IR camera according to the related art includes a processor and a display (e.g., LCD) to provide a preview image to the user. The user recognizes whether a presentation region is included within the vision field of the IR camera while viewing the preview image. Further, when the presentation region and the vision field of the IR camera are misaligned, the user may adjust a direction of a lens of the IR camera so the presentation region is included within the vision field. The IR camera is further used for recognizing a track of the electronic pen in the electronic blackboard system. However, the processor and the display are required for initial alignment but are not required for subsequent use in the IR camera.

The calibration is an operation which maps a pixel grid (i.e., display resolution) of an image captured by the IR camera to a pixel grid of an image to be projected to a screen. Calibration is needed to ensure that the user's handwriting, which is based on the detected image, is accurately reproduced by the projector. In one calibration technique, the projector projects reference points at four corners of an image projected on the screen under remote control of the controller. The user marks the reference points with the electronic pen. Accordingly, the electronic pen radiates the IR rays from the reference points. The IR camera captures the screen image and outputs the imaged result to the controller. The screen image, however, only represents a portion of the entire image captured by the IR camera; it is the entire image that is forwarded to the controller. The controller recognizes a portion of the entire image corresponding to a presentation region, that is, a square region connecting the reference points to each other, as the general region encompassed within the reference points. The controller maps pixels of the recognized part (e.g., full display resolution of shooting region may be 640*480, and pixel grid of the presentation region may be 320*240) to pixels (e.g., 1280*760) of the image projected on the screen.

In the calibration according to the related art, it is essential to mark the reference point with the electronic pen. However, the above manual operation may be inconvenient. For example, there may be a reference point to which a user's hand cannot reach.

### SUMMARY

Embodiments described herein perform alignment and calibration for an electronic blackboard system in an automated manner by setting sensitivity of an infrared camera to detect visible rays.

Embodiments further provide for setting an electronic blackboard system by enabling alignment without providing a preview image to a user through a separate display unit other than a projection screen.

Also provided is a method of setting an electronic blackboard system which enables calibration without using an electronic pen.

In an embodiment of a method of setting an electronic blackboard system, in response to a user input requesting setting of an electronic blackboard, sensitivity of an infrared (IR) camera is set so that visible rays are detected. A projector is controlled to project, to a screen, a presentation region with a first guider therein for alignment. A first captured image of the presentation region is received from the IR camera, which includes at least a portion of the first guider. The projector is controlled to project to the screen at least a portion of a second guider corresponding to the at least a portion of the first guider in the first image received from the IR camera. In this manner, the user may then make positional adjustments to the IR camera or the projector so as to achieve alignment of the IR camera's field of view and the presentation region projected by the projector.

In accordance with another embodiment, a method of setting an electronic blackboard system comprises: detecting a request event for setting an electronic blackboard from a user interface unit; setting sensitivity of an infrared camera so that visible rays are detected when the request event for setting the electronic blackboard is detected; controlling a projector to project, to a screen, a presentation region with a first guider for alignment and calibration for mapping pixels of a recognized part to pixels of an image to be projected on the screen; receiving an image including at least a portion of the first guider from the infrared camera; controlling the projector to project to the screen at least a portion of a second guider corresponding to the at least a portion of a first guider in the first image received from the infrared camera; detecting a completion event of the alignment from the user interface unit; recognizing a region corresponding the presentation region from the image; and mapping pixels of the recognized part to pixels of an image to be projected on the screen and storing the mapped result.

Exemplary electronic devices for implementing the methods are also disclosed.

### BRIEF DESCRIPTION OF THE DRAWINGS

The aspects, features and advantages of the present invention will be more apparent from the following detailed description in conjunction with the accompanying drawings, in which:

FIG. 1 is a diagram illustrating a configuration of an electronic blackboard system according to an exemplary embodiment of the present invention;

FIG. 2 is a graph illustrating a characteristic of an infrared filter according to an exemplary embodiment of the present invention;

FIG. 3 is a block diagram illustrating a control apparatus according to an exemplary embodiment of the present invention;

FIG. 4 is a flowchart illustrating a method of setting an electronic blackboard system according to an exemplary embodiment of the present invention;

FIGS. 5 and 6 are diagrams illustrating electronic blackboard setting pictures for alignment projected on a screen through a projector, according to embodiments;

FIG. 7 illustrates an exemplary projection screen that may be displayed for calibration following alignment operations, according to an embodiment;

FIG. 8 is a conceptual diagram illustrating a procedure of mapping a display resolution according to an exemplary embodiment of the present invention; and

FIG. 9 is a flowchart illustrating a method of setting an electronic blackboard system according to another exemplary embodiment of the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Herein, “shooting” and like forms refers to an operation of a camera capturing an image of a subject, whether by capturing visible light or infrared light emanating from the subject.

Herein, “setting” an electronic blackboard system can mean aligning an IR camera's field of view with a presentation region projected by a projector. “Setting” can also refer to such aligning in addition to calibrating a pixel grid of an image provided by the IR camera with a pixel grid of an image frame projected by the projector.

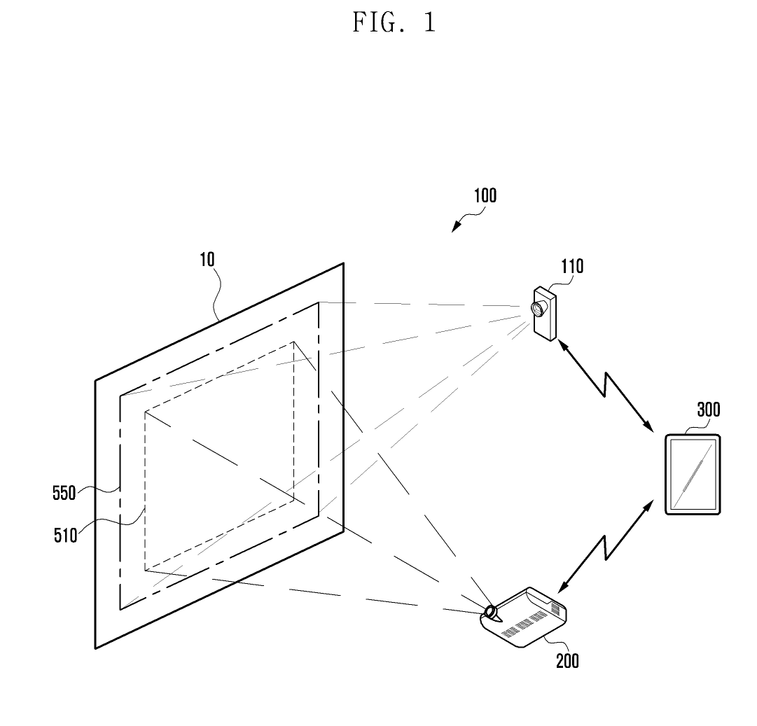

FIG. 1 is a diagram illustrating a configuration of an electronic blackboard system, 100, according to an exemplary embodiment of the present invention. Electronic blackboard system 100 may include an infrared (IR) camera 110, a projector 200, a control apparatus 300, and an electronic pen (not shown). The user writes with the electronic pen on a screen 10 which operates as a virtual blackboard.

Various types of electronic pens can be utilized in embodiments of the present invention. In one suitable type of electronic pen, a nib is attached to an infrared LED and the LED is turned ON to emit infrared rays when the nib touches the screen 10. In another exemplary type of electronic pen, a button is provided at the pen's elongated body and an infrared LED at a nib of the pen is turned ON to emit infrared rays when the user presses the button.

The IR camera 110 captures an image of a subject, particularly, by detecting infrared rays at points over a field of view such as defined by a boundary 550 on the screen 10, and outputs the captured image to the control apparatus 300. In FIG. 1, the IR camera's field of view 550 is shown aligned with a presentation region 510 of an image projected by projector 200. As will become apparent from the description hereafter, in an electronic blackboard setting scheme of the present embodiment, to set the blackboard system 100 and thereby align the IR camera field of view 550 with the presentation region 510, a first “guider” image is generated and projected around the periphery of presentation region 510. When the field of view 550 is initially misaligned with presentation region 510, the IR camera captures only a partial image of the guider, and transmits the captured image to control apparatus 300. Control apparatus 300 then controls generation of a second guider image, which is projected on screen 10 and provides and an indication of the misalignment. This indication allows the user to adjust the IR camera 110 relative to the projector 200 to achieve proper alignment before actual use of the electronic blackboard system 100. In this manner, the user need not utilize the electronic pen to effectuate such proper alignment.

In detail, the IR camera 110 may include a lens collecting light, an IR filter filtering and outputting infrared rays from the light collected in the lens, an image sensor (e.g., CMOS(Complementary Metal Oxide Semiconductor) or CCD(Charge Coupled Device)) converting the light output from the IR filter into an electrical signal, a signal processor A/D (Analog to Digital) converting the electrical signal output from the image sensor into image information (e.g., RGB data or YUV data), a radio frequency (RF) communication unit transmitting the image information to control apparatus 300 in a wireless scheme, and an internal controller controlling infrared shooting. The controller may control the infrared shooting under remote control of the control apparatus 300 through the RF communication unit. The RF communication unit is a near field communication module for communicating with control apparatus 300, and for example, may include a Wi-Fi module and/or a Bluetooth module. Further, for example, the IR camera 110 may further include an external device interface unit for communicating with the control apparatus 300 in a wired scheme through Universal Serial Bus (USB) cable. IR camera 110 may further include a manual adjusting unit for manually adjusting a direction of the lens in up, down, left and right directions. IR camera 110 may further include an automatic adjusting unit (e.g., including a motor) adjusting a direction of the lens in up, down, left and right directions. The controller of IR camera 110 may control the automatic adjusting unit under remote control of the control apparatus 300 through the RF communication unit. IR camera 110 may be integrated with one of the projector 200 and the control apparatus 300 in some embodiments. When the IR camera 110 is so integrated, the RF communication unit among the foregoing constituent elements may be omitted.

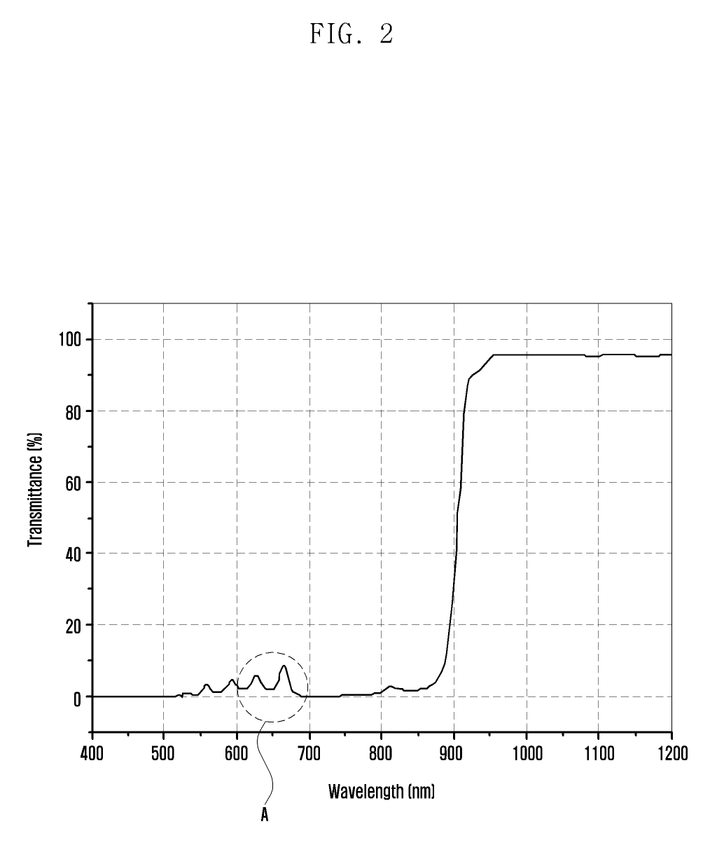

FIG. 2 is a graph illustrating a characteristic of an infrared filter within IR camera 110 according to an exemplary embodiment of the present invention. IR camera 110 may adjust sensitivity of the image sensor under the remote control of the control apparatus 300. Although in the IR filter, a visible ray has transmittance lower than that of the infrared ray, the visible ray may still propagate through (traverse) the IR filter. An IR filter that passes an infrared ray as well as a visible ray or a part thereof is referred to a dual band IR filter. An example of passing a part of a visible ray would be passing a narrow band around 610 nm, corresponding to a red color, of incident light encompassing other bands. The transmittance is the ratio of an intensity of light at the output of the IR filter to an intensity of light incident to the IR filter. In general, the higher the sensitivity of the image sensor, the more the image sensor reacts to light. Accordingly, for example, when sensitivity of the image sensor is set to a maximum value (e.g., 100%), an electric signal output from the image sensor may include image information associated with visible rays. Conversely, when the sensitivity of the image sensor is set to a minimum value (e.g., 10%), the electric signal output from the image sensor of the IR camera 110 does not include image information associated with the visible rays but may include image information associated with only IR rays. In detail, referring to FIG. 2, the IR filter may pass a part (e.g., “A”; red) of visible rays having transmittance lower than that of the IR ray (e.g., wavelength of 780 nm or greater). In the IR camera including the IR filter, when the sensitivity of the image sensor is set to the maximum value (e.g., 100%), the image sensor may output image information corresponding to a red color in the visible rays as well as the infrared rays. Accordingly, it should be appreciated that the graph of FIG. 2 corresponds to an exemplary transmittance for the IR filter at a high or maximum sensitivity of a dual band IR filter.

The signal processor of the IR camera 110 may convert RGB data into YUV data, for example, using the following equation 1 to output the converted YUV data.

$$Y = {w}_{R} R + {W}_{G} G + {W}_{B} B \\ U = {U}_{Max} \frac{B - Y}{1 - {W}_{B}} \\ V = {V}_{Max} \frac{R - Y}{1 - {W}_{R}} \qquad [ Equation 1 ]$$

where, W_{R}, W_{G}, W_{B}, U_{Max} and V_{Max} are preset constants, respectively.

The projector 200 receives an image from the control apparatus 300 and projects the received image to screen 10 over the presentation region 510. To receive the image to be projected, the projector 200 may include an RF communication unit such as a Wi-Fi module and/or a Bluetooth module for communicating with the control apparatus 300 and/or an external device interface unit for communicating with the control apparatus 300 in a wired scheme.

The control apparatus 300 generally controls an electronic blackboard system of the present invention. Particularly, the control apparatus 300 may be a portable electronic device such as a notebook PC, a tablet PC, a smart phone or a general portable terminal.

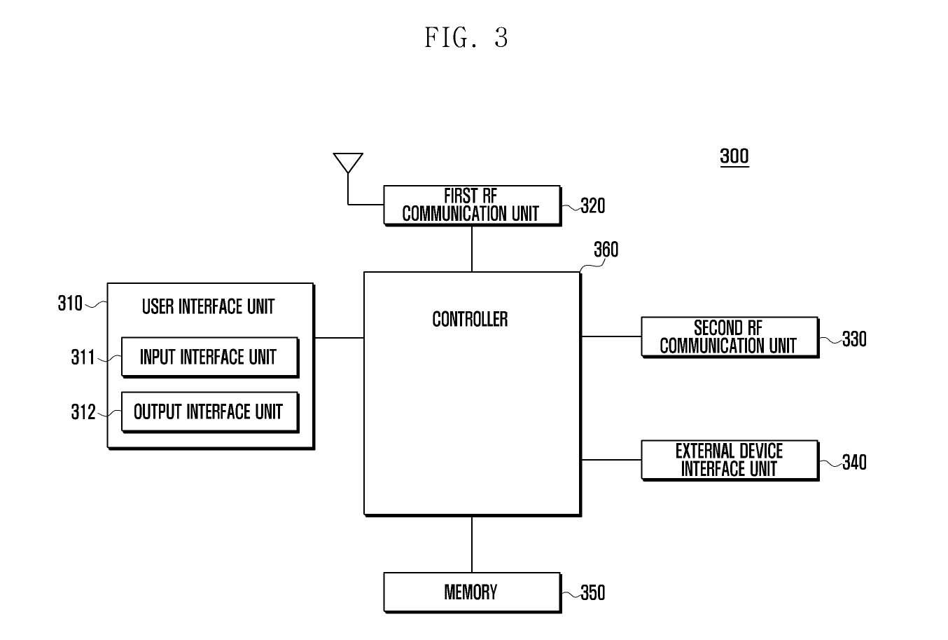

FIG. 3 is a block diagram illustrating an exemplary control apparatus 300 according to an exemplary embodiment of the present invention. Control apparatus 300 may include a user interface unit 310, a first RF communication unit 320, a second RF communication unit 330, an external device interface unit 340, a memory 350, and a controller 360.

The user interface unit 310 serves as an interface for interaction with a user, and may include an input interface unit 311 and an output interface unit 312 visibly, audibly, or with tactile feedback to the user in response to input information received from the input interface 311. For example, the input interface unit 311 may include a touch panel, a microphone, a sensor, and a camera. The output interface unit 312 may include a display unit, a speaker, and a vibration motor.

The touch panel of the input interface unit 311 may be placed on the display unit. The touch panel generates an analog signal in response to a user gesture (e.g., Tap, Double Tap, Long tap, Drag, Drag & Drop, Flick, and Press), converts the analog signal into a digital signal, and transfers the digital signal to the controller 360. The touch panel and the display unit may constitute a touch screen. The controller 360 may detect a touch event from the touch panel, and control the control apparatus 300 in response to the detected touch event. The microphone receives a sound such as a user's speech, converts the received sound into an electric signal, Analog to Digital (AD)-converts the electric signal into audio data, and outputs the audio data to the controller 360. The controller 360 may detect speech data from audio data received from the microphone, and may control the control apparatus 300 in response to the detected speech data. A sensor detects a state change of the control apparatus 300, and generates and outputs detection data associated with the detected state change to the controller 360. For example, the sensor may include various sensors such as an acceleration sensor, a gyro sensor, a luminance sensor, a proximity sensor, and a pressure sensor. The controller 360 may detect the detection data from the sensor and may control the control apparatus 300 in response to the detection data. An internal camera may be included to shoot a subject, unrelated to the electronic blackboard function.

The display unit of the output interface unit 312 drives pixels in accordance with image data from the controller 360 to display an image. The display unit may display various pictures according to use of the control apparatus 300, for example, a lock picture, a home picture, an application (referred to as ‘App’) execution picture, and a key pad. If the display unit is initially turned-on, the lock picture may be displayed. If a user gesture (e.g., tap of an input means such as the user's finger or stylus pen) with respect to a touch screen for releasing lock is detected, the controller 360 may change a displayed image from the lock picture to the home picture or the App execution picture. The home picture may be defined as an image including a plurality of icons corresponding to a plurality of Apps. When one (e.g., icon for executing an electronic blackboard App) is selected (e.g., taps the icon) from a plurality of App icons by a user, the controller 360 may execute a corresponding App and may display an execution picture on the display unit. The display unit may display a plurality of pictures under control of the controller 360. For example, the display unit may display a key pad on a first region and display an image projected on a screen through the projector 200 on the second region. The display unit may include a display panel such as a Liquid Crystal Display (LCD), an Organic Light Emitted Diode (OLED) or an Active Matrix Organic Light Emitted Diode (AMOLED). The speaker converts audio data from the controller 360 into a sound and outputs the sound. The vibration motor provides haptic feedback. For example, when touch data are detected, the controller 360 vibrates the vibration motor.

The first RF communication unit 320 and the second RF communication unit 330 communicate with an external device in a wireless scheme.

The first RF communication unit 320 may support at least one of a Global System for Mobile Communication (GSM) network, an Enhanced Data

GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, and a Bluetooth network.

The second RF communication unit 330 may support a Wi-Fi system. Further, the second RF communication unit 330 may include a first band communication unit and a second band communication unit, and may transceive different frequency band signals through respective band communication units. For example, the first band communication unit and the second band communication unit may support 2.4 GHz and 5 GHz, respectively, and may support different frequency bands according to a design scheme. Accordingly, the second RF communication unit 330 may receive a first frequency band signal from the IR camera 110, and may transmit a second frequency band signal to the projector 200. Conversely, the second RF communication unit 330 may transmit the first frequency band signal to the IR camera 110, and may receive the second frequency band signal from the projector 200. Further, the second RF communication unit 330 may simultaneously receive or transmit the first and second frequency band signals. Meanwhile, the first frequency band and the second frequency band may share some or all of the same frequencies. In the latter case, the first frequency band and the second frequency band may be determined as an orthogonal channel which does not overlap with each other. For example, the first frequency band and the second frequency band may be determined as a 2.4 GHz band. The 2.4 GHz band includes total 14 channels, an interval between channels is 5 MHz, and each channel has a 22 MHz band. Further, when channels 1, 6, and 11 do not overlap with each other, the first frequency band is determined as the channel 1 and the second frequency band is determined as channel 6 or 11.

The external device interface unit 340 connects with an external device in a wired scheme (e.g., USB cable). That is, the control apparatus 110 may perform data communication with the IR camera 110 and the projector 200 through the external device interface unit 340 instead of the second RF communication unit 330.

The memory 350 is a secondary memory unit, and may include a NAND flash memory. The memory 350 may store data (e.g., character messages, shot images) generated by the control apparatus 300 or data received from the exterior.

The memory 350 may store various preset values (e.g., picture brightness, presence of vibration upon generation of a touch, presence of automatic rotation of a picture) for operating the control apparatus 300. The memory 350 may store a booting program, an Operating System (OS) and various application programs for operating the control apparatus 300. The application program may include an embedded application and a 3rd party application. The embedded application refers to an application basically embedded in the control apparatus 300. For example, the embedded application may include a browser, an e-mail, an instant messenger, and an electronic blackboard App. The electronic blackboard App is a program which calculates a track of an electronic pen using image information received from the IR camera 110 and controls the projector 200 to display the track on the screen 10 by the controller 360. Particularly, the electronic blackboard App may include a function for alignment and calibration. The electronic blackboard App may include the 3rd party application. As generally known in the art, the 3rd party application refers to various applications which are downloaded and installed in the control apparatus 300 from an on-line market. The 3rd party application is freely installed and removed. If the control apparatus 300 is turned-on, a booting program is loaded into a primary memory unit (e.g., RAM). The booting program loads the OS into the primary memory unit so that the control apparatus 300 may operate. The OS loads an application program into the primary memory unit and is executed. The booting and loading is generally known in a computer system, and thus a detailed description is omitted.

The controller 360 controls an overall operation and signal flow between internal constituent elements of the control apparatus 300, and processes data. Further, the controller 360 may include a primary memory unit having an application program and an OS, a cache memory temporarily storing data to be recorded in the memory 350 and data read from the memory 220, a central processing unit (CPU), and a graphic processing unit (GPU). The OS serves as interface between hardware and an application program to manage computer resources such as the CPU, the GPU, the primary memory unit, and a secondary memory unit. That is, the OS operates the control apparatus 300, determines an order of tasks, and controls calculations of the CPU and the GPU. In addition, the OS performs a function controlling execution of the application program and a function managing storage of data and files. Meanwhile, as generally known in the art, the CPU is a core control unit of a computer system performing calculation and comparison of data, and interpretation and execution of commands. The GPU is a graphic control unit performing calculation and comparison of a graphic, and interpretation and execution of commands instead of the CPU. The CPU and the GPU may be integrated as one package where at least two independent cores (e.g., quad-core) are contained within a single integrated circuit. The CPU and the GPU may be a system on chip (SoC) for providing a plurality of individual parts as one package. The CPU and the GPU may be packaged in a multi-layer. In the meantime, a configuration including the CPU and the GPU may be referred to as an Application Processor (AP).

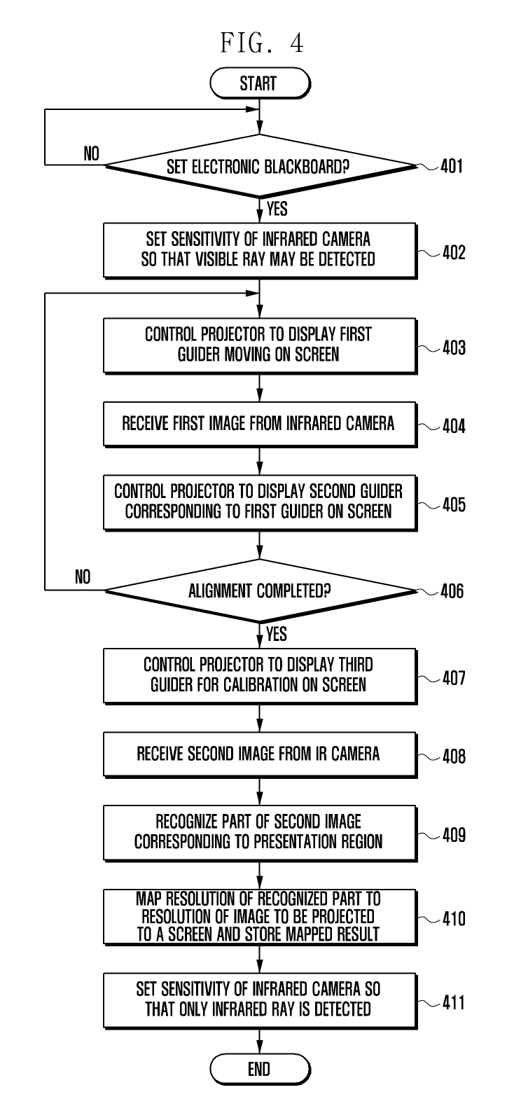

Particularly, the controller 360 of the present invention performs alignment and calibration. The above functions will be described in detail with reference to FIGS. 4 to 9.

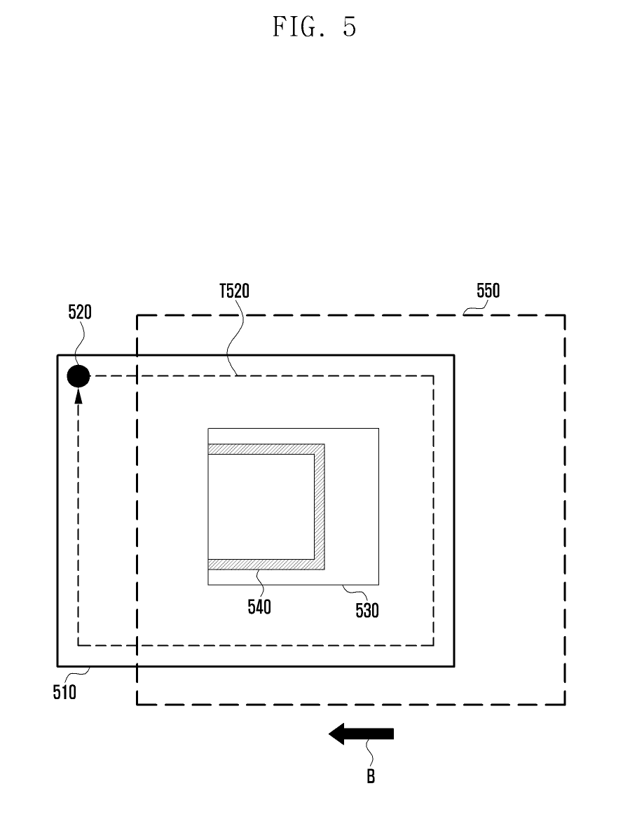

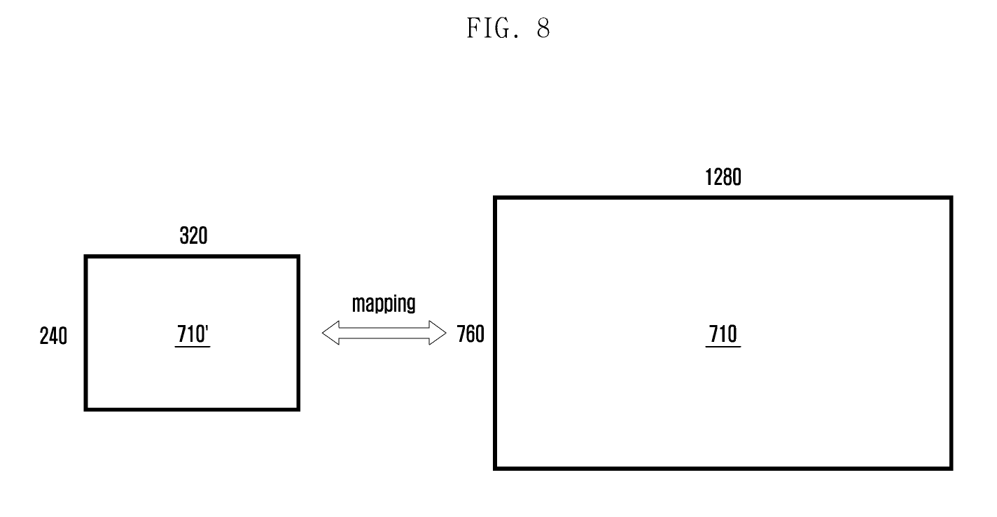

FIG. 4 is a flowchart illustrating a method of setting the exemplary electronic blackboard system 100 according to an exemplary embodiment of the present invention. FIGS. 5 to 7 illustrate example electronic blackboard setting pictures projected on a screen through a projector. FIG. 8 is a conceptual diagram illustrating a procedure of mapping pixel grids according to an exemplary embodiment of the present invention. In the following description, the various steps of the method will be indicated parenthetically following corresponding description.

Referring to FIG. 4, controller 360 may detect a request event (e.g., tap with respect to a corresponding icon displayed on a touch screen) for executing an electronic blackboard from the user interface unit 310. When the request event is detected, the controller 360 may display a corresponding App execution picture on a touch screen. The controller 360 may control the second RF communication unit 330 or the external device interface unit 340 to perform a connection procedure for performing data communication with IR camera 110 and the projector 200. If IR camera 110 and the projector 200 are connected, the above procedure is omitted. Next, the controller 360 may detect a request event (e.g., tap a ‘setting icon’ displayed on the touch screen) for setting the electronic blackboard from the user interface unit 310, for example, the touch screen (401).

When the request event for setting the electronic blackboard is detected, the controller 360 sets sensitivity of an IR camera 110 so that a visible ray may be detected (402). In detail, the controller 360 controls a second RF communication unit 330 to transmit a request message for requesting such that a shooting mode of the IR camera 110 is determined as an ‘electronic blackboard setting mode’. The shooting mode of the IR camera 110 may include an electronic blackboard setting mode which detects visible rays to set an electronic blackboard, and a presentation mode which displays a track of an electronic pen on a screen 10. An RF communication unit of the IR camera 110 receives and transfers the request message to its internal controller. The IR camera controller initially sets the sensitivity of an image sensor to, for example, 100% so that the image sensor may detect visible rays in response to the request message.

As shown in FIG. 5, the controller 360 controls a projector 200 to display an alignment guider 520 (example of a ‘first guider’) moving on a presentation region 510 (403). It is noted here that the term “guider” can refer to a small guider element, such as the ball 520, which appears to move in a sequence of frames around a perimeter path T520 so as to present an alignment guide in a moving image. Alternatively, a specific guider element such as the shown ball 520 can be omitted, and just an image of the guider track T520 in a distinct color may be displayed along the presentation region 510 perimeter. In this case, “guider” can mean the perimeter track T520, and the complete guider is displayable in a still frame image.

In any event, as mentioned earlier, presentation region 510 is a region on screen 10 to which light (image) is projected and is a background of alignment guider 520. In a moving image alignment guider embodiment, the controller 360 controls the second RF communication unit 330 or the external device interface unit 340 to transmit an alignment request message to the projector 200 together with an image including a movable alignment guider 520. The projector 200 projects the movable alignment guider 520 to the screen 10 in response to an alignment request of the control apparatus 300. The image including the movable alignment guider 520 may be stored in a memory of the projector 200. In this case, the controller 360 transmits only the alignment request message to the projector 200. In the example of FIG. 5, the alignment guider 520 may move along an edge of the presentation region 510 and may return to a first start position. Further, the alignment guider 520 may move along a diagonal line of the presentation region 510.

A color of the alignment guider 520 is determined based on a visible light transmission characteristic of an IR filter of the IR camera 110. For example, referring to example characteristic of FIG. 2 in which the IR filter passes red light, the controller 360 may be provided with the filtering characteristic information beforehand, or it may be determined empirically via various color projections by the projector 200 and image feedback from the IR camera. When the filtering information is obtained, controller 360 determines a color of the alignment guider 520 as a red hue corresponding to wavelength in the range of 620 nm to 780 nm, determines a color of the presentation region 510, e.g., a background as black, and controls the projector 200 to display a red alignment guider 520 on a black background. Accordingly, the IR camera 110 shoots (detects) the red alignment guider 520, and transmits a first image including a track of the alignment guider 520 to the control apparatus 300. The color of the background image 510 is not limited to the black color; other colors such as yellow may be utilized, which the IR camera 110 does not detect or only minimally detects. Meanwhile, a shape of the alignment guider 520 is not limited to a circular ball; various other shapes are available. Further, as mentioned above, the alignment guider 520 may be a static image rather than a dynamic image. For example, the controller 360 may control the projector 200 to display edges of the presentation region 510 as an alignment guider with a red color, with or without displaying a guider element such as the illustrated ball.

With continued reference to FIGS. 4 and 5, the controller 360 receives a first image from the IR camera 110 which includes, if the IR camera 300 is at least partially aligned with the presentation region 510, at least a portion of a track of the alignment guider 520. This image generated by IR camera 110 is received through the second RF communication 330 or the external device interface unit 340 (404).

Based on the image received from IR camera 110, controller 360 controls the projector 200 to display another guider (second guider) 540 corresponding to the captured image of alignment guider 520 received from the IR camera 110 on the screen 10 (405). For example, the second guider may be a track of the first guider, that is, the alignment guider 520. The controller 360 may set a color of this track as a color of wavelength which the IR camera 110 cannot detect, and may control the projector 200 to display a track of the determined color (that is, second guider). In the shown exemplary embodiment, the second guider 540 is displayed within a colored presentation region 530 (or just a colored outline) that is centrally located within the presentation region 510. In FIG. 5, is it seen that the field of view 550 of the IR camera 110 does not capture the entire area of the presentation region 510, thus the IR camera 110 and projector 200 are misaligned. As illustrated, due to the misalignment, only the right hand side of the guider track T520 is captured by IR camera 110, and thus the image provided thereby to the control apparatus 300 only includes the right hand side of guider track T520. Consequently, the second guider 540, which is representative of the captured image, only includes the right hand side of track T520, thereby serving as an indication to the user to adjust either the position of IR camera 110 or the position of the projector 200.

Now, a display resolution (size of pixel grid) of a first image shot by the

IR camera 110 and transmitted to the control apparatus 300 may be lower than that of the presentation region 510 projected on the screen 10. For example, the display resolution of the presentation region 510 may be 1280(horizontal)*760(vertical), and the resolution of the first image may be 640(horizontal)*480(vertical). Further, in the example, the first image overlaps with a part of the presentation region 510 to be displayed on the screen 10. As shown in FIG. 5, the projector 200 may display the second region or outline 530 corresponding to the display resolution of the first image on a partial region of the presentation region 510 and displays the track 540 corresponding to the captured image of the alignment guider 520 in the region or outline 530 under remote control of the controller 360. It is preferable that colors of the region or outline 530 and the track 540 can be recognized by a user's eyes but are colors which the IR camera 110 cannot detect. For example, when the IR camera 110 can detect only a red color from visible rays, the region or outline 530 and the track 540 may be a blue color. That is, the controller 360 sets a color of the first image projected on the screen 10 so that the IR camera 110 can shoot only the alignment guider 520. Meanwhile, when the resolution of the first image received from the infrared camera 110 is higher than that of the presentation region 510, the controller 360 may adjust the resolution of the first image to be lower than that of the presentation region 510 (that is, resize the first image to be smaller than the background image 510). The smaller resized first image may be displayed on the presentation region 510.

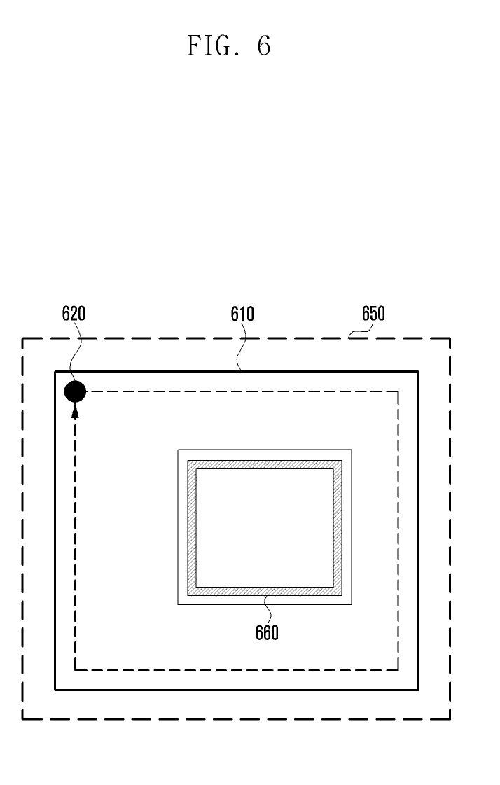

The controller 360 may detect a completion event (e.g., a tap on a completion icon displayed on a touch screen) of alignment or an event (e.g., a tap on a restart icon) requesting restart of the alignment from the user interface unit 310 (406). In FIG. 5, field of view 550 represents a region shot by the IR camera 110. As shown, due to initial misalignment, the shooting region 550 and the presentation region 510 cross each other, i.e., the shooting region 550 does not encompass the entire presentation region 510. When the IR camera 110 does not shoot the whole presentation region 510, the track 540 projected on the presentation region 510 may be different from an actual track of the alignment guider 520. In this case, the user recognizes that the alignment is not achieved, and may adjust a direction of a lens of the IR camera 110 and/or a distance between the IR camera 110 and the screen 10 (e.g., adjust the direction of the lens in the direction “B”) and/or a pointing direction or position of the projector 200. Next, the user may tap a restart icon displayed on a touch screen of the control apparatus 300. Accordingly, the controller 360 again performs steps 403 to 405. Referring to FIG. 6, when the presentation region 610 is included in the shooting region 650, the track 660 projected to the presentation region 610 corresponds to an actual track of the alignment guider 620 in shape. In this case, the user recognizes that the alignment is completed, and may tap an alignment completion button displayed on a touch screen of the control apparatus 300.

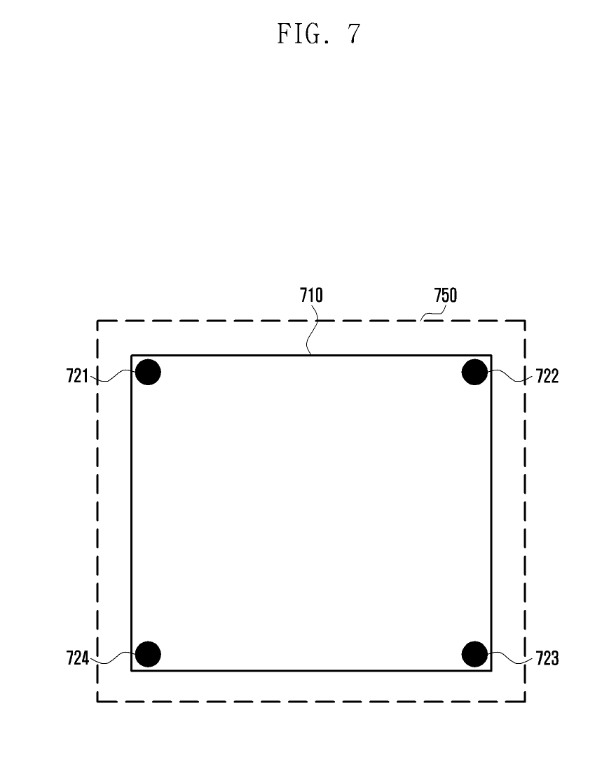

FIG. 7 illustrates an exemplary projection screen for calibration that may be displayed following the above-described alignment operations. Here, controller 360 controls the projector 200 to display calibration guiders 721 to 724 (example of a “third guider”) on the presentation region 710 (407). Further, colors of the calibration guiders 721 to 724 are determined based on a visible ray transmitting characteristic of the IR filter of the IR camera 110. For example, referring to FIG. 2, the controller 360 obtains the transmittance vs. wavelength information of the IR filter and based thereon, determines suitable colors of the calibration guiders 721 to 724 as a red corresponding to wavelength in the range of 620 nm to 780 nm. Controller 360 may also determine, based on the filter characteristics, a color of the presentation region 710, that is, a background as black, and controls the projector 200 to display red calibration guiders 721 to 724 on the background. As shown in FIG. 7, the calibration guiders 721 to 724 may be displayed at four corners of the presentation region 710. In addition, the calibration guiders 721 to 724 may be simultaneously or sequentially displayed. Note that other geometric shapes besides circles may be designated for the calibration guiders 721 to 724.

Additionally, the controller 360 may control the projector 200 to display a perimeter outline of the presentation region 710 as a calibration guider with a red color. The IR camera 110 detects the calibration guiders 721 to 724, and transmits a first image (corresponding to a shooting region 750) including the calibration guiders 721 to 724 to the control apparatus 300.

The controller 360 receives a second image including the calibration guiders 721 to 724 from the IR camera 110 through the second RF communication unit 330 or an external device interface unit 340 (408). The controller 360 then recognizes, based on the imaged guiders and/or a colored perimeter outline, a part of the second image corresponding to the presentation region 710 (409). For instance, referring to FIG. 8, the controller 360 maps a display resolution (pixel grid) of an image 710′ received from the IR camera 110, e.g., 320*240 of the recognized part to a display resolution, e.g., 1280*760 of the presentation region 710 image (the latter being the image projected to screen 10 through the projector 200) and stores the mapped result (410). With such calibrated mapping, when the user subsequently writes on a point of the presentation region 710 using the electronic pen, the precise location of the point can be properly recognized through a captured image of the IR camera 110. Using suitable scaling and interpolation, the controller 360 can then generate a writing mark at a pixel location in the projected image corresponding to the captured point and control projection of the writing mark in the next projected image.

Next, the controller 360 completes the calibration by setting sensitivity of the IR camera 110 so that only IR rays are detected (shot) (411). That is, the controller 360 changes a shooting mode of the IR camera 110 from an electronic blackboard setting mode to a presentation mode. When the IR camera 110 is changed to a presentation mode, the sensitivity of the IR camera 110 may be set to a minimum value (e.g., 10%) so that only infrared rays, and not visible rays, are detected. The control apparatus 300 recognizes a touched point and a track of an electronic pen from an image received from the IR camera 110. Further, the controller 300 calculates a touched point of the screen 10 and a handwriting path in the screen 10 using the stored mapping information, and controls the projector 200 to display the calculated path on the screen 10.

Meanwhile, during the above-described calibration operation, the controller 360 may recognize the calibration guiders 721 to 724 using a ‘Y’ value (that is, brightness of calibration guider) in YUV data in the electronic blackboard setting mode. In this case, recognition failure may occur due to peripheral environments (e.g., bright environment, dark environment, and reflection light, etc.). The greater the distance between projector 200 and screen 10, the lower the brightness of the calibration guiders 721 to 724. This reduced brightness may cause a recognition failure. A ‘V’ value (color of a calibration guider and chromatic aberration of nearby color thereof) is used to recognize the calibration guiders 721 to 724, whereby recognition failure may be reduced. That is, the controller 360 may recognize the calibration guiders 721 to 724 using the V value in the YUV data.

As described above, according to the present embodiments, alignment is possible without providing a preview image to a user through a separate display unit other than a screen. The calibration is possible without using an electronic pen. Moreover, alignment guiders such as 721 to 724 may be used as a guide for calibration.

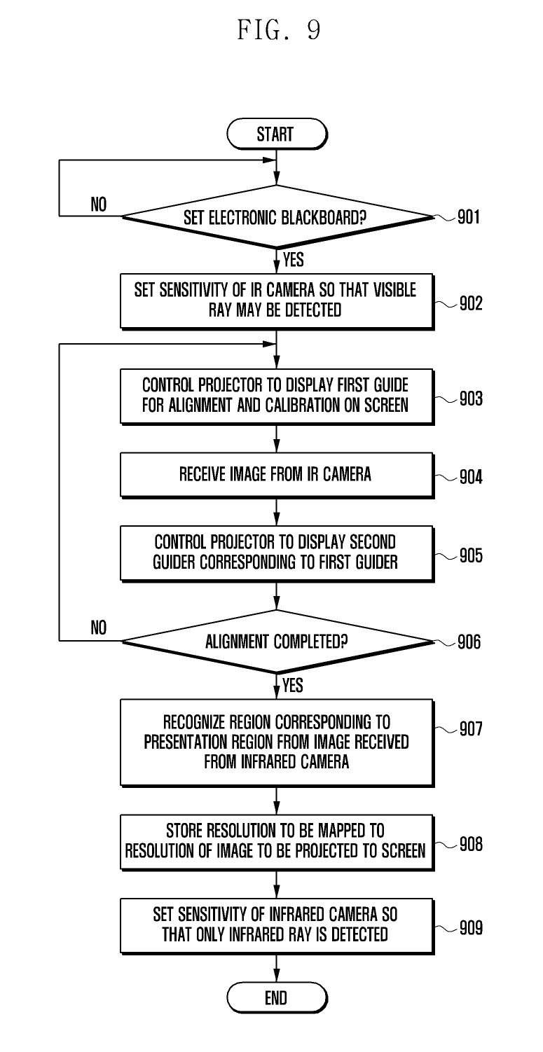

FIG. 9 is a flowchart illustrating a method of setting an electronic blackboard system according to another exemplary embodiment of the present invention. This embodiment differs from that of FIG. 4 primarily by displaying a guider for both alignment and calibration in one initial operation, rather than projecting a separate calibration image following the alignment procedure. The method begins by controller 360 detecting a request event (e.g., tap a ‘setting button’ displayed on the touch screen) for setting an electronic blackboard from the user interface unit 310, for example, the touch screen (901).

When the request event for setting the electronic blackboard is detected, the controller 360 sets the sensitivity of the IR camera 110 so that visible rays may be detected (902).

The controller 360 controls the projector 200 to display a first guide for both alignment and calibration on a presentation region (903). The presentation region is a region on a screen 10 to which light (image) is projected. As shown e.g. in FIG. 5, the first guider may move along an edge of the presentation region and may return to a first start position. Further, the first guider may move along a diagonal line of the presentation region 5. The first guider may be a static image rather than a movable image. For example, the first guider may have a circular ball which is simultaneously or sequentially displayed at four corners of the presentation region 710. Further, the controller 360 may control the projector 200 to display an edge of the presentation region as a first guider with a red color.

The controller 360 receives an image including a guider from the IR camera 110 through the second RF communication unit 330 or the external device interface unit 340 (904).

The controller 360 controls the projector 200 to display a second guider corresponding to the first guider received from the IR camera 110 to the screen 10 (905). The second guider may be the track of first guider. The controller 360 may determine a color of the second guider as a color of wavelength which the IR camera 110 cannot shoot (detect).

The controller 360 may detect an alignment completion event (tap a completion button displayed on the touch screen) or a request event for restarting the alignment (e.g., tap a restart button) from the user interface unit 310 (906). When the user requests restart of the alignment, the controller 360 again performs steps 903 to 905.

When the alignment is completed, the controller 360 may recognize a region corresponding to the presentation region from the image received from the IR camera (907). The controller 360 maps a resolution (e.g., 320*240; see FIG. 8) to a resolution (e.g., 1280*760; see FIG. 8) of an image to be projected to the screen 10 through the projector 200 and stores the mapped result (908). After that, with the calibration completed, the controller 360 sets the sensitivity of the IR camera 110 so that only infrared rays are detected, whereby a presentation mode may begin.

The foregoing methods of the present invention may be implemented through execution of an executable program by various computer means, where the program may be recorded in a computer readable recording medium. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used. Examples of the computer readable recording medium include Magnetic Media such as hard disk, floppy disk, or magnetic tape, Optical Media such as Compact Disc Read Only Memory (CD-ROM) or Digital Versatile Disc (DVD), Magneto-Optical Media such as optical disk, and a hardware device such as ROM, RAM, or flash memory storing and executing program commands. Further, the program command can be a machine language code created by a compiler or a high-level language code executable by a computer using an interpreter. The foregoing hardware device may be configured to be operated as at least one software module to perform an operation of the present invention.

As described above, the method and the apparatus according to the present invention can set the sensitivity of the IR camera 110 so that only infrared rays are detected (shot) to perform alignment and calibration. Particularly, according to methods and apparatus of the present invention, the alignment is possible without providing a preview image through a separate display unit other than a screen. Further, the calibration is possible without using the electronic pen.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of setting an electronic blackboard system, the method comprising:
in response to a user input requesting setting of an electronic blackboard, setting sensitivity of an infrared camera so that visible rays are detected;
controlling a projector to project, to a screen, a presentation region with a first guider therein for alignment;
receiving, from the infrared camera, a first captured image of the presentation region including at least a portion of the first guider; and
controlling the projector to project to the screen at least a portion of a second guider corresponding to the at least a portion of the first guider in the first image received from the infrared camera.

2. The method of claim 1, wherein the controlling of the projector comprises:
determining a color of the first guider as a color which the infrared camera detects from the set sensitivity; and
controlling such that the first guider is displayed as the determined color.

3. The method of claim 2, wherein the controlling of the projector further comprises:
controlling such that the second guider is displayed with a color which the infrared camera does not detect.

4. The method of claim 1, further comprising;
detecting a completion event of the alignment from a user interface unit;
controlling the projector to display a third guider for performing calibration, the calibration being an operation of mapping pixels of an image shot by the infrared camera to pixels of an image to be projected to the screen;
receiving a second image including the third guider from the infrared camera;
recognizing a region corresponding to the presentation region from the second image; and
mapping pixels of the recognized part to pixels of an image to be projected on the screen and storing the mapped result.

5. The method of claim 4, wherein the controlling of the projector to display the third guider on the screen comprises controlling such that a plurality of third guider elements are displayed in at least four corners of the presentation region.

6. The method of claim 1, wherein the controlling of the projector comprises moving the first guider in a sequence of frames along a periphery of the presentation region.

7. The method of claim 6, wherein the second guider comprises a track of the first guider moving along the periphery.

8. The method of claim 1, wherein the first guider is an outline of a track displayed along a periphery of the presentation region, having a color that differs from a color of the presentation region.

9. A method of setting an electronic blackboard system, the method comprising:
detecting a request event for setting an electronic blackboard from a user interface unit;
setting sensitivity of an infrared camera so that visible rays are detected when the request event for setting the electronic blackboard is detected;
controlling a projector to project, to a screen, a presentation region with a first guider for alignment and calibration for mapping pixels of a recognized part to pixels of an image to be projected on the screen;
receiving an image including at least a portion of the first guider from the infrared camera;
controlling the projector to project to the screen at least a portion of a second guider corresponding to the at least a portion of a first guider in the first image received from the infrared camera;
detecting a completion event of the alignment from the user interface unit;
recognizing a region corresponding the presentation region from the image; and
mapping pixels of the recognized part to pixels of an image to be projected on the screen and storing the mapped result.

10. An electronic device comprising:
a radio frequency (RF) communication unit communicating with an infrared camera and a projector;
a user interface unit interacting with a user;
a controller controlling the RF communication unit and the user interface unit,
wherein the controller is configured to:
control the infrared camera through the RF communication unit to set sensitivity of the infrared camera so that visible rays are detected when a request event for setting an electronic blackboard is detected from the user interface unit, and controls the projector through the RF communication unit such that a first guider for performing alignment is projected within an image of a presentation region on a screen;
receive a first image including at least a portion of the first guider from the infrared camera through the RF communication unit; and
control the projector through the RF communication unit to display at least a portion of a second guider corresponding to the at least a portion of the first guider in the first image received from the infrared camera on the screen.

11. The electronic device of claim 10, wherein the controller determines a color of the first guider as a color which the infrared camera detects from the set sensitivity, and controls the projector through the RF communication unit such that the first guider is displayed as the determined color.

12. The electronic device of claim 11, wherein the controller controls the projector through the RF communication unit such that the second guider is displayed with a color which the infrared camera does not detect.

13. The electronic device of claim 10, wherein the controller is further configured to:
control the projector to display a third guider for performing calibration, the calibration being an operation of mapping pixels of an image shot by the infrared camera to pixels of an image projected to the screen when a completion event of the alignment is detected from the user interface unit;
receive a second image including the third guider from the infrared camera;
recognize a region corresponding the presentation region from the second image; and
map pixels of the recognized part to pixels of an image to be projected on the screen and store the mapped result.

14. The electronic device of claim 13, wherein the controller controls such that a plurality of third guider elements are displayed in at least four corners of the presentation region.

15. The electronic device of claim 10, wherein the controller controls such that the first guider is moved in a sequence of frames and controls such that a track of the first guider received from the infrared camera is displayed in a moving image sequence.

16. An electronic blackboard system comprising the electronic device of claim 10.

17. A computer readable storage medium comprising computer executable instructions for performing the method according to claim 1.
